(19) United States
(12) Patent Application Publication
(10) Pub. No.: US 2016/0101514 A1
(43) Pub. Date: Apr. 14, 2016

(54) Folding Sawhorse

(71) Applicant: Barclay Moore, Tahoe City, CA (US)

(72) Inventor: Barclay Moore, Tahoe City, CA (US)

(21) Appl. No.: 14/844,774

(22) Filed: Sep. 3, 2015

Related U.S. Application Data
(60) Provisional application No. 62/062,990, filed on Oct. 13, 2014.

(51) Int. Cl. B25H 1/06

(52) U.S. Cl. CPC B25H 1/06

(57) ABSTRACT

The folding sawhorse for use in creating a workbench. The folding sawhorse includes a pair of panels each having a lower end and an upper end, wherein the upper ends are pivotally secured to one another. The panels are preferably rectangular in configuration and able to stand upright, similar to a conventional sawhorse. The folding sawhorse further includes a shelf wherein a first end thereof is pivotally secured to the second panel and a second end thereof can rotate so as to allow the shelf to pivot between a horizontal and a vertical position. The folding sawhorse is movable between a folded and a working configuration. In the working configuration, the folding sawhorse forms an A-shape having the shelf horizontally disposed between the pair of panels. In the folded configuration, the panels are positioned flush against one another, whereby the shelf is disposed within an opening of the second panel.

### CROSS REFERENCE TO RELATED APPLICATION

This application claims the benefit of U.S. Provisional Application No. 62/062,990 filed on Oct. 13, 2014. The above identified patent application is herein incorporated by reference in its entirety to provide continuity of disclosure.

### BACKGROUND OF THE INVENTION

### Field of the Invention

The present invention relates to folding sawhorses. More specifically, the present invention provides a folding sawhorse comprising a first panel pivotally secured to a second panel at an upper end thereof, wherein each panel comprises an opening thereon. A shelf is pivotally secure to the second panel, wherein the folding sawhorse is movable between a folded and a working configuration. In the working configuration, the folding sawhorse forms an A-shape having the shelf horizontally disposed between the pair of panels. In the folded configuration, the pair of panels are positioned flush against one another and the shelf is disposed within the opening of the second panel for storing and transportation.

Many professional contractors and carpenters have to travel between various job sites transporting the necessary tools and building materials to complete their work. In addition to having to transport tools and other materials, these individuals must find adequate work space in which to properly use the tools. Unfortunately, there is a limited amount of space in which a contractor or carpenter can transport and set up a proper workbench. Conventional sawhorses enable such individuals to create a temporary workbench. However, the sawhorses are large and bulky. Thus, they are difficult to efficiently transport and store, along with the necessary tools and other building materials needed. Therefore, there exists a need in the prior art for a device that is easily folded into a compact configuration for storing and transporting.

Devices have been disclosed in the prior art that relate to folding sawhorses. These include devices that have been patented and published in patent application publications. These devices generally relate to foldable sawhorses comprising a shelf slidably secured to the frame, such as U.S. Pat. No. 6,488,119 and U.S. Pat. No. 5,351,785. Other devices generally relate to foldable sawhorses comprising a shelf having a collapsible center section that enables the sawhorse to fold, such as U.S. Pat. No. 5,560,448, U.S. Pat. No. 6,712,180, and U.S. Pat. No. 6,298,946. Another device, U.S. Pat. No. 4,113,056, generally relates to a sawhorse comprising a foldable shelf that can be fastened to the frame via a buckle.

These prior art devices have several known drawbacks. The devices in the prior art fail to provide a foldable sawhorse comprising a pair of panels each having an opening with a similar shape as a shelf disposed therebetween, wherein the opening of one of the panels is adapted to receive the shelf therein. Further, the devices fail to disclose a first end of the shelf pivotally secured to a second panel, wherein a second end of the shelf is disposed through the opening of a first panel and supported thereon. Some devices comprise a frame having a shelf pivotally secured to one side of the frame and slidably secured to a second side of the frame, however, the attachment methods require excess components in order to secure the shelf thereto. Thus, the prior art devices fail to disclose a foldable sawhorse having a panel configured to receive a shelf therein so as to allow the panels to rest flush against one another in a folded configuration.

In light of the devices disclosed in the prior art, it is submitted that the present invention substantially diverges in design elements from the prior art and consequently it is clear that there is a need in the art for an improvement to existing folding sawhorses. In this regard the instant invention substantially fulfills these needs.

### SUMMARY OF THE INVENTION

In view of the foregoing disadvantages inherent in the known types of folding sawhorses now present in the prior art, the present invention provides a new folding sawhorse wherein the same can be utilized for providing convenience for the user when creating a work table.

It is therefore an object of the present invention to provide a new and improved folding sawhorse that has all of the advantages of the prior art and none of the disadvantages.

It is another object of the present invention to provide a folding sawhorse comprising a first panel and a second panel each having an upper end and a lower end, wherein the upper end of the first panel is pivotally secured to the upper end of the second panel.

Another object of the present invention is to provide a folding sawhorse wherein each panel comprises an opening thereon, wherein the opening on the first panel is adapted to receive a shelf therethrough and the opening on the second panel is adapted to receive a shelf therein.

Yet another object of the present invention is to provide a folding sawhorse further comprising a shelf having a first end and a second end, wherein the first end is pivotally secured to the second panel and the second end can rotate so as to allow the shelf to pivot between a horizontal and a vertical position.

Yet another object of the present invention is to provide a folding sawhorse wherein the second end of the shelf rests on a support comprising a rectangular shape, wherein the support extends upwards from a lower end of the opening on the first panel.

Yet another object of the present invention is to provide a folding sawhorse wherein the folding sawhorse is movable between a folded configuration wherein the shelf is positioned within the opening of the second panel and the panels are disposed flush against one another, and a working configuration wherein the lower ends of the panels are separated from one another and the shelf is disposed horizontally therebetween.

Another object of the present invention is to provide a folding sawhorse that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of an embodiment of the folding sawhorse.

FIG. 2 shows a rear perspective view of an embodiment of the folding sawhorse.

FIG. 3 shows a perspective view of the folding sawhorse wherein the shelf is positioned for securement onto the first panel.

FIG. 4 shows a perspective view of an embodiment of the folding sawhorse disposed in a folded configuration.

### DETAILED DESCRIPTION OF THE INVENTION

Reference is made herein to the attached drawings. Like reference numerals are used throughout the drawings to depict like or similar elements of the folding sawhorse. For the purposes of presenting a brief and clear description of the present invention, the preferred embodiment will be discussed as used for creating a workbench or table. The figures are intended for representative purposes only and should not be considered to be limiting in any respect.

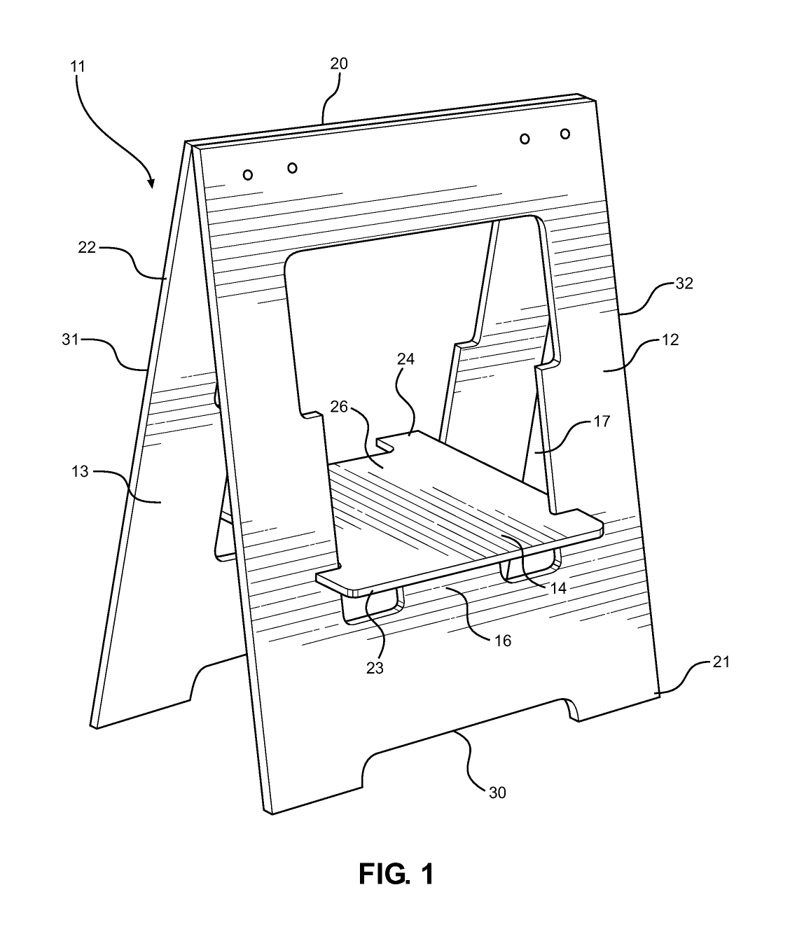

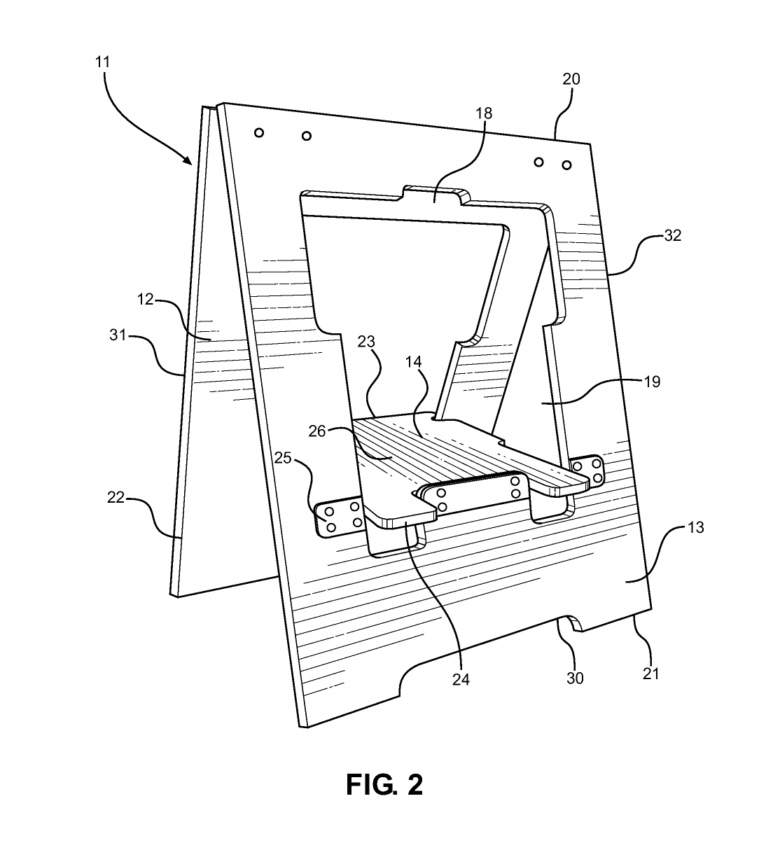

Referring now to FIGS. 1 and 2, there is shown a front perspective view of an embodiment of the folding sawhorse and a rear perspective view of an embodiment of the folding sawhorse, respectively. The folding sawhorse 11 comprises a first panel 12 and a second panel 13 each having a lower end 21 and an upper end 20. The upper end 20 of the first panel 12 is pivotally secured to the upper end 20 of the second panel 13, wherein the lower ends 21 thereof are freely separable from one another. Preferably, each panel 12, 13 comprises a rectangular shape. However, in the illustrated embodiment, the lower end 21 of the panels 12, 13 comprise a U-shaped recess 30 that provides an area in which a user can grasp when the lower ends 21 of the folding sawhorse 11 are positioned on a horizontal support surface.

The upper end 20 of each panel 12, 13 is linear so as to receive a horizontally disposed plank thereon in order to create a workbench, wherein the folding sawhorse 11 is disposed in an upright position as shown. Alternatively, the folding sawhorse 11 is further adapted to be positioned horizontally. Conventionally, one or more additional sawhorses are needed in order to create a stable workbench from the plank or other table top. However, the lateral edges 22 of the panels 12, 13 are linear and a first side 31 of the folder sawhorse 11 is parallel to a second side 32 thereof so as to allow a single folding sawhorse 11 to support a table top or plank thereon. In this way, the folding sawhorse 11 can be positioned such that the first side 31 of the folding sawhorse 11 can receive a table top thereon and the second side thereof can be disposed on a horizontal support surface, such as the ground. The combination of the linear edges 22 with the separable lower ends 21 of the panels 12, 13 provides a stable base for a table top to be positioned thereon.

The folding sawhorse 11 further comprises a planar shelf 14 having a first side 26, a second side, a first end 24, and a second end 23, wherein first side 26 is adapted to be stepped upon and support various tools thereon. The first end 24 of the shelf 14 is pivotally secured to the second panel 13. The shelf 14 is pivotally secured to the second panel 13 by any suitable hinge, including piano hinges and butt hinges. In the illustrated embodiment, the hinge comprises a rod that extends through the second end 24 of the shelf 14 and into grooves disposed on the second panel 13. A plurality of metal plates 25 are used to secure the rod in position. The second end 23 of the shelf 14 is adapted to rotate so as to allow the shelf 14 to pivot between a horizontal and a vertical position.

The second panel 13 includes an opening 19 that extends between the lower and upper ends 20, 21 of the panel 13. The opening 19 is configured to receive the entire shelf 14 therein. Preferably, the edges of the opening 19 are adapted to align flush with the edges of the shelf 14, with the exception of a cutout 18 disposed on the upper end of the opening 19. The cutout 18 allows a user to place his or her hand therein in order to conveniently carry the sawhorse 11. Preferably, the shape shelf 14 has a similar shape of the opening 19 so as to allow the shelf 14 to fit securely therein. Furthermore, the similar shape of the opening 19 and the shelf 14 incorporates the additional benefit of allowing a user to save material and labor costs when manufacturing of the folding sawhorse 11. The material in which the opening 19 of the panel 13 is formed from can serve as the shelf 14 of the folding sawhorse 11.

The first panel 12 comprises the same shape as the second panel 13 and includes an opening 17 that extends between the upper and lower ends 20, 21 thereof. The opening 17 of the first panel 12 is adapted to receive the second end 23 of the shelf 14 therethrough. A support 16 extends upwards from the lower end 21 of the opening 17 of the first panel 12, wherein the second end 23 of the shelf 14 is adapted to rest thereupon. In the illustrated embodiment, the support 16 is rectangular in shape having a linear upper edge in order to allow the shelf 14 to remain stable thereon. However, in alternate embodiments, the support 16 can comprise other suitable shapes so long as the second end 23 of the shelf 14 can rest stably thereon.

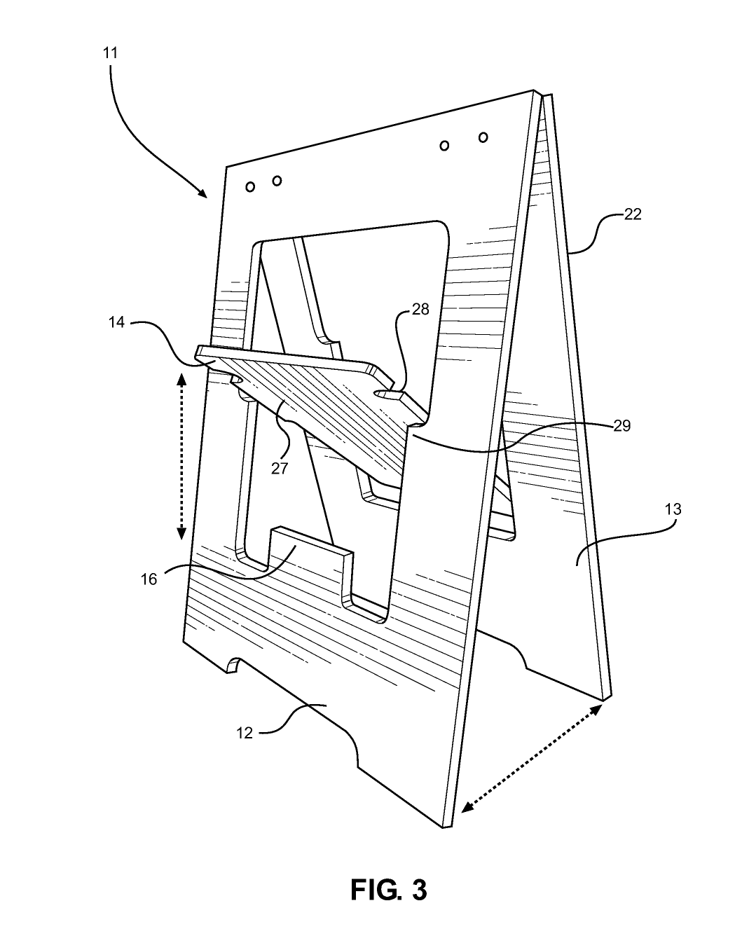

Referring now to FIG. 3, there is shown a perspective view of the folding sawhorse wherein the shelf is positioned for securement onto the first panel. In the illustrated embodiment, the shelf 14 comprises a locking mechanism having pair of slots 28 adapted to receive a pair of protrusions 29 disposed on the first panel 12 so as to removably secure the shelf 14 thereto. The shelf 14 is adapted to be stepped upon and also receive tools thereon. Thus, it is important for the shelf 14 to remain stable and secured to the panels 12, 13 while in use.

The slots 28 are positioned near the second end 23 of the shelf 14, on opposing lateral edges thereof and directly across from one another. The protrusions 29 are aligned in the same plane as the panel 12, wherein each protrusion 29 extends upwards into the opening 17 on opposing sides thereof. Preferably, the width of the slot 28 is the same as the width of the protrusion 29 so as to allow the shelf 14 to securely remain on the panel 12. The locking mechanism allows the shelf 14 to removably secure to the first panel 12 without the requirement of additional components, such as fasteners.

The folding sawhorse 11 is movable between a folded configuration and working configuration. In the working configuration, the panels 12, 13 are adapted to stand upright wherein the shelf 14 is disposed horizontally therebetween, forming an A-shaped configuration. During the transition to the working configuration, the shelf 14 is adapted to pivot until the slots 28 engage the protrusions 29 and slide downward therealong until the second side 27 of the shelf 14 rests flush on the support 16. In the working configuration, the folding sawhorse 11 is adapted to allow a user to stand on the shelf 14, rest his or her tools on the shelf 14, or utilize the folding sawhorse 11 to create a workbench by disposing the sawhorse 11 horizontally and placing a tabletop on the linear, lateral edges 22 thereof.

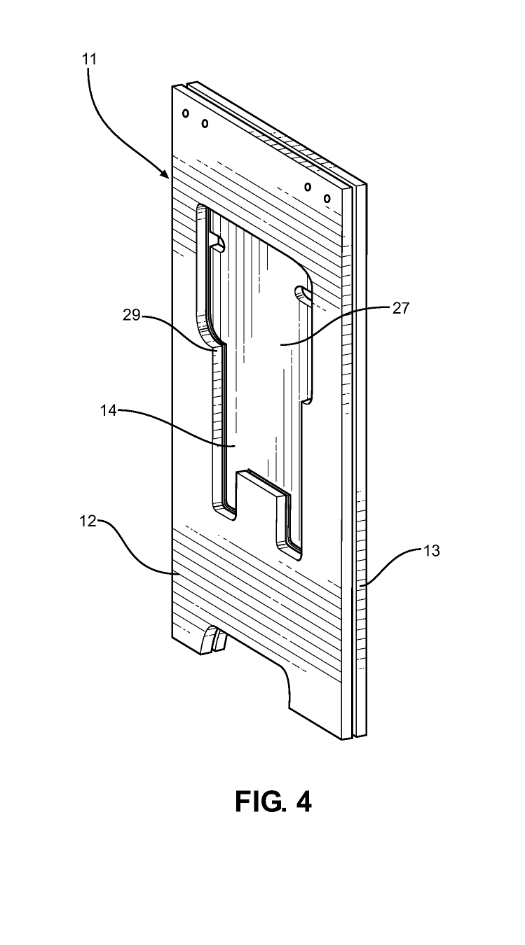

Referring now to FIG. 4, there is shown a perspective view of an embodiment of the folding sawhorse disposed in a folded configuration. In the folded configuration, the shelf 14 is disposed within the opening of the second panel 13 and the panels 12, 13 are disposed flush against one another. During the transition to the folded configuration, the second end of the shelf 14 is adapted to pivot towards the upper end of the second panel 13, wherein the slots slide upwards along the protrusions 29 and disengage therefrom. The shelf 14 is then disposed within the opening of the second panel 13, wherein the panel 13 and shelf 14 lie in the same plane. The lower ends of the panels 12, 13 are moved towards one another, wherein the first panel 12 rests flush against the second panel 13 and the second side 27 of the shelf 14. Preferably, the shelf 14 comprises the same thickness, or a smaller thickness, than the thickness of the second panel 13 to prevent the shelf 14 from protruding beyond the surface thereof so as to allow the first panel 12 to rest flush against the second panel 13. Thus, the folding sawhorse 11 is disposed in a compact configuration for storing and convenient transport thereof.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A folding sawhorse, comprising:
a first panel and a second panel each having an upper end and a lower end, wherein said upper end of said first panel is pivotally secured to said upper end of said second panel;
an opening disposed on said second panel, wherein said opening extends between said upper end and said lower end thereof;
a shelf having a first end and a second end, wherein said first end of said shelf is pivotally secured to said second panel and said second end of said shelf is adapted to rotate so as to allow said shelf to pivot between a horizontal position and a vertical position;
wherein said shelf, said first panel, and said second panel are movable between a working configuration wherein said lower end of said first panel is separated from said lower end of said second panel and said shelf extends horizontally from said second panel and is removably secured to said first panel to form an A-shaped configuration, and a folded configuration wherein said shelf is positioned within said opening of said second panel so that said shelf aligns within said second panel and said first panel is disposed flush against said second panel.

2) The folding sawhorse of claim 1, further comprising an opening disposed on said first panel, wherein said opening extends between said upper end and said lower end thereof and is adapted to receive said second end of said shelf therethrough when disposed in said working configuration.

3) The folding sawhorse of claim 1, wherein said shelf corresponds to a shape of said opening of said second panel.

4) The folding sawhorse of claim 1, wherein said first panel and said second panel are each rectangular in shape.

5) The folding sawhorse of claim 1, wherein said shelf comprises a pair of slots each disposed on opposing lateral edges of said shelf, directly across from one another, and said first panel comprises a pair of protrusions extending upward from opposing edges of said opening of said first panel and adapted to receive said pair of slots thereon, such that said shelf is removably secured to said first panel in said working configuration.

6) The folding sawhorse of claim 1, wherein said second panel comprises a cutout disposed on an upper end of said opening of said second panel configured to receive a user's hand therethrough.

7) The folding sawhorse of claim 1, wherein said first panel comprises a support extending upward from said lower end thereof and into said opening of said first panel, wherein said support is adapted to receive said first end of said shelf thereon.

8) The folding sawhorse of claim 1, wherein said lower end of said first panel and said lower end of said second panel each comprise a U-shaped recess.
